(19) United States
(12) Patent Application Publication
(10) Pub. No.: US 2009/0213808 A1
(43) Pub. Date: Aug. 27, 2009

(54) Maintenance of data connections during the changeover of a communication access network

(75) Inventors: Wolfgang Boehm, Buchloe (DE); Gerhard Kieselmann, Muenchen (DE); Peter Kim, Berlin (DE); Alexander Milinski, Muenchen (DE)

Correspondence Address: LERNER GREENBERG STEMER LLP, P O BOX 2480, HOLLYWOOD, FL, 33022-2480, US

(73) Assignee: Nokia Siemens Networks GmbH & Co. KG, Muenchen (DE)

(21) Appl. No.: 11/887,198

(22) PCT Filed: Mar. 30, 2006
(86) PCT No.: PCT/EP2006/061202

§ 371 Date: Dec. 16, 2008

(30) Foreign Application Priority Data
Apr. 1, 2005 (DE) 10 2005 015 111.6

(51) Int. Cl. H04W 36/06

(52) U.S. Cl. 370/331

(57) ABSTRACT

A method for maintaining at least one data connection to a terminal during a changeover from a first communication access network to at least one second communication access network, comprising at least two private user identities and at least two IP addresses are allocated to the terminal in order to form a public user identity for the user of the terminal, wherein the terminal registers itself in an IP communication network in parallel per communication access network with in each case one private user identity and with the common public user identity and an IP address for the first communication access network and the at least one second communication access network.

The invention relates to a method for maintaining at least one data connection to a terminal during a changeover from a first communication access network to at least one second communication access network.

Terminals, for example mobile radio terminals, mobile computers, computers, mobile organizers, a fixed network telephone etc. are increasingly becoming multi-modal, that is to say they can support a variety of radio systems and access technologies such as, for example, a WLAN network in addition to a UMTS communication network and a GSM communication network. It is therefore necessary to maintain the services when the radio technology changes, that is to say during a handover between the different radio technologies.

To be differentiated from the communication access networks are the associated IP communication networks which provide access to the IP-based services of the network operator and which are connected to the communication access networks. As a rule these are specific to the communication access network. For the GSM communication networks and the UMTS communication networks, these are for example the common GPRS system or GPRS communication network here; as a rule a different separate communication access network is used for WLAN access. A change in radio technology (not between GSM and UMTS, but between WLAN and GSM/UMTS) therefore necessitates changing the communication access network as well.

The question of maintaining services on changing the radio technology is thus in particular a question of maintaining the services on changing the communication access network.

This issue is currently being examined in 3GPP SA2. There are two related, but different problems:
1) How can existing IP multimedia services be maintained when the radio technology, and consequently the communication access network, changes?
2) How can continuity of service be provided between a packet-based voice-over-IP connection in a WLAN and a connection-oriented CS (circuit-switched) voice connection on a changeover of the radio technology between GSM/UMTS and WLAN?

In the case of the second question it is assumed that the GSM and also the UMTS communication network cannot/should not (yet) be used for voice connections over IP.

To date there are no generally known complete solutions for public communication networks which address this problem.

The following approaches are however generally known:
a) In principle the use of the “Mobile IP” protocol enables IP-based services to be maintained when the communication access network (IP access network) changes. Mobile IP is however not suited to mobile radio communications according to 3GPP because the combination with the GPRS architecture becomes very inefficient (additional mobile IP tunnel above the GTP tunnel).
b) For companies in particular (enterprise segment), there is the option of using a three-way conference. For this a voice connection between the multi-modal terminal and the call partner is temporarily extended as for a three-way conference. In this case the terminal is linked in twice (using the two radio technologies). The disadvantage is that a conference server is required, which doubles the payload data. In an enterprise environment, this can be accomplished relatively easily, since the issues of location and load distribution can be solved relatively easily. This is a difficult challenge for public communication networks.
c) Another option is to use the same communication access network for different radio systems. Examples of this are the so-called “tunnel extension” which was standardized in 3GPP specification TS 23.234, Annex F, or the UMA specifications (http://www.umatechnology.org). The disadvantages of such a solution are the greatly increased complexity of IP access over WLAN, and that the connection of broadband WLAN access networks places a not inconsiderable additional load on the GPRS access network optimized for mobile radio communications.

The object of the invention is to propose a simple and efficient way of maintaining a data connection during the changeover of a communication access network.

According to the invention, the object is achieved by the subject-matter of the independent claims. Further developments of the invention are set out in the subclaims.

One key aspect of the invention is that, for maintaining at least one data connection to a terminal during a changeover from a first communication access network to at least one second communication access network, the terminal obtains at least two IP addresses for the same “public” user identity (for example an IMS public user identity) and registers itself in an IP communication network in parallel per communication access network with the one common (the same public user identity for the private user identities) “public” user identity and with in each case one “private” user identity (IMS private user identity) and an IP address for the first and the at least one second communication access network. The public user identity (IMS public user identity) and the private user identity (IMS private user identity) are standardized in the 3GPP standard TS 23.228. A private user identity may be a user identifier with a password for example. In this case, said private user identity may be configured by the terminal and/or by a network unit, for example the HSS unit (Home Subscriber Server). The terminal can then use the IP multimedia subsystem according to 3GPP or 3GPP2. However, firstly the terminal must have an IP address and an IP connection to the IP multimedia subsystem; this is provided for example by the GPRS network or by the WLAN network; secondly it must register itself in the IMS. An authentication is performed here. The “private” user identity is used for authentication. Above all, however, from the SIP point of view the IMS public user identity permanently known in the IP multimedia subsystem IMS and the terminal, for example a SIP-URI, a Tel-URI etc., is “linked” to the current IP address, that is to say requests for the SIP-URI are now sent to this IP address. A packet-switching communication network, a WLAN network, a GPRS network (or the analog for CDMA networks, namely the multimedia domain) and/or a cellular mobile radio network may be used here as the communication access network. An IP multimedia subsystem or a similar IP communication network may be used as the IP communication network for example. A terminal is usually only registered over one communication access network. According to the invention, a plurality of user identities (IMS private user identities) are allocated to a single multi-modal terminal, preferably one per communication access network in each case. Said user identities are configured in the terminal and on the network-side. The terminal can consequently register itself in an IP communication network in parallel over different communication access networks with the same “public” user identity without one registration replacing the others. In particular, a registration thus does not terminate the connections (sessions) that were set up over another communication access network.

According to the invention, a (multi-modal) terminal, for example a mobile radio terminal, a mobile computer, a mobile-organizer, a fixed network telephone, a set-top box (device for videotelephony and for receiving (digital) television channels over an IP communication network), a computer etc. is considered which obtains access using different radio technologies to different communication access networks or IP access systems (IP-CANs) that enable in each case access to the IP services of the network operator, in particular services over the IP multimedia subsystem IMS.

In the IP multimedia subsystem IMS, or more generally in SIP networks (communication networks that use the SIP protocol for signaling), logically speaking the terminal maintains for a voice or data service firstly a signaling connection to the SIP servers in the communication network (in IMS: CSCF=Call State Control Function), and secondly a “connection” for the payload data (usually end-to-end). According to the invention, different communication access networks or IP access networks respectively can be used for the signaling and the payload data. This is enabled by the SIP/SDP protocol for example. The terminal can consequently send its payload data over the broadband WLAN network for example (a first communication access network), but can route the SIP signaling to the IP multimedia subsystem over the GPRS network (a second communication access network). This aspect of the invention is neither limited to one communication access network nor to one signaling protocol. Thus, for example, in addition to the SIP protocol, it is also possible to use the H.323 protocol, an IP-based signaling protocol etc. as the signaling protocol.

According to the invention the changeover of the communication access network for payload data and for signaling is at least logically separate. On a changeover of the communication access network for the payload data to a second communication access network, an existing signaling connection over a first communication access network can be retained. If, for instance, a signaling connection (for example a SIP dialog) exists over a communication access network (IP-CAN) which controls or monitors a payload data connection (session) over the same or a different communication access network (IP-CAN), then a renewal of, for example, the SIP dialog by means of, for example, a re-INVITE message enables the payload data connection to be changed. It should of course be possible for both the signaling connection and the payload data connection to be handed over from the first communication access network to the second communication access network. In some circumstances a further scenario may be that the payload data connection is retained with the first communication access network and only the signaling connection to the second communication access network is changed. In this case, the option to use different IP addresses or user identities respectively in SIP/SDP is used. If, for example, initially payload data is routed over a WLAN network but the signaling is routed over a GPRS network, then using the re-INVITE message it is possible from now on to also route, for example, the voice connection over the GPRS network or vice versa. Conversely, by means of the re-INVITE message it is of course equally possible to separate the signaling and the payload data initially transmitted over the same communication access network IP-CAN.

If the terminal has registrations with two different communication access networks and a payload data connection that was established over one of the communication access networks, then according to the invention it is possible to hand over the control channel, that is to say the signaling connection, from a first communication access network to the second communication access network: SIP signaling is used for this purpose for example, namely either by means of the REFER procedure, which invokes a call diversion, or a new INVITE procedure with “Replaces header”. The “Replaces header” causes one SIP dialog to replace another. In both cases the payload connection is retained. According to the invention, the communication access network for the payload connection can be optionally changed at the same time.

There are mechanisms which enable a CS connection (circuit-switched connection) to be viewed as a (possibly single) component of an IMS SIP connection. Said mechanisms use a variant of SIP “3rd party call control”, see for example alternative A in the 3GPP TR 23.899 specification, and usually also a (logical) application server (called CBCF in the 3GPP TS 23.899 specification).

One major advantage of the invention is that technically it represents a comparatively simple solution to a complex problem, in particular if “CS Bearer Control” is already implemented.

Another advantage is that the existing signaling protocols can be used with minimal modification so the invention is consequently easy to implement.

A further advantage of the invention is that when changing from voice-over-IP in a WLAN to voice in the CS domain, the application server required (e.g. CBCF), which performs the monitoring (SIP 3rd party call control), need not be in the connection path from the outset. Rather, it is added into the connection only as a result of a signaling procedure (for example INVITE) with “Replaces header” for example.

The invention will be explained in greater detail with reference to an exemplary embodiment illustrated in the figures, in which:

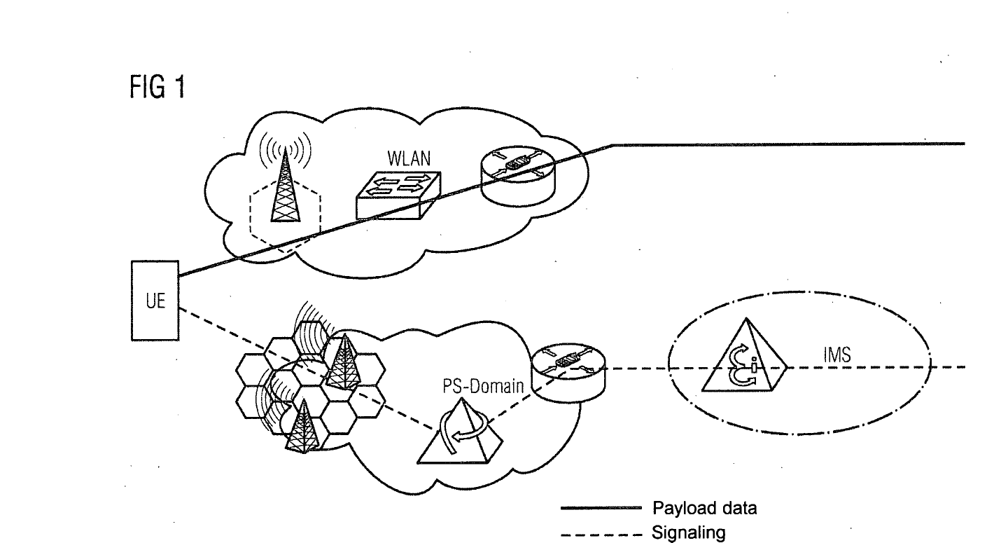

FIG. 1 shows a simplified system architecture with signaling and payload data which is transmitted over different communication access networks,

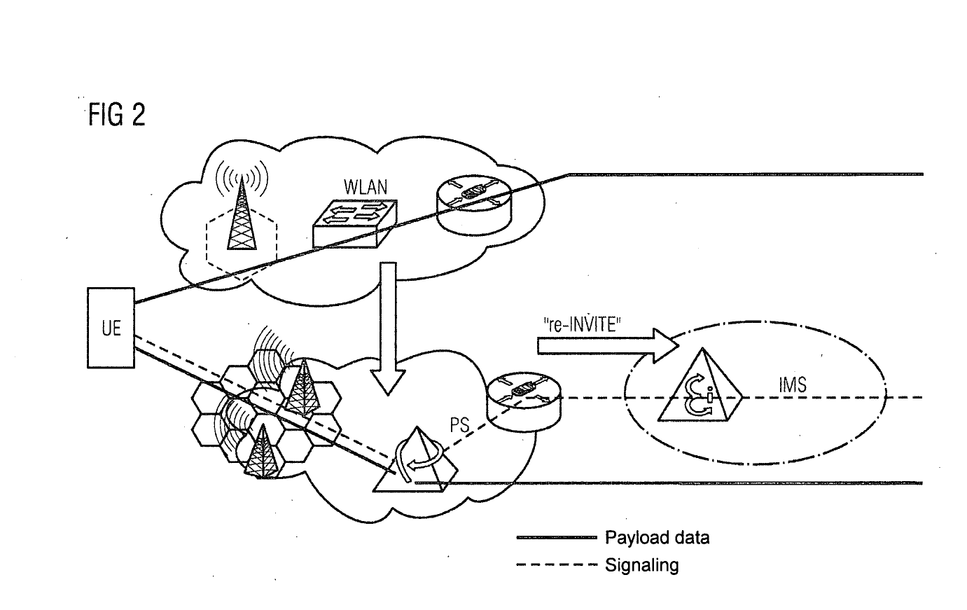

FIG. 2 shows a changeover of the communication access network for payload data,

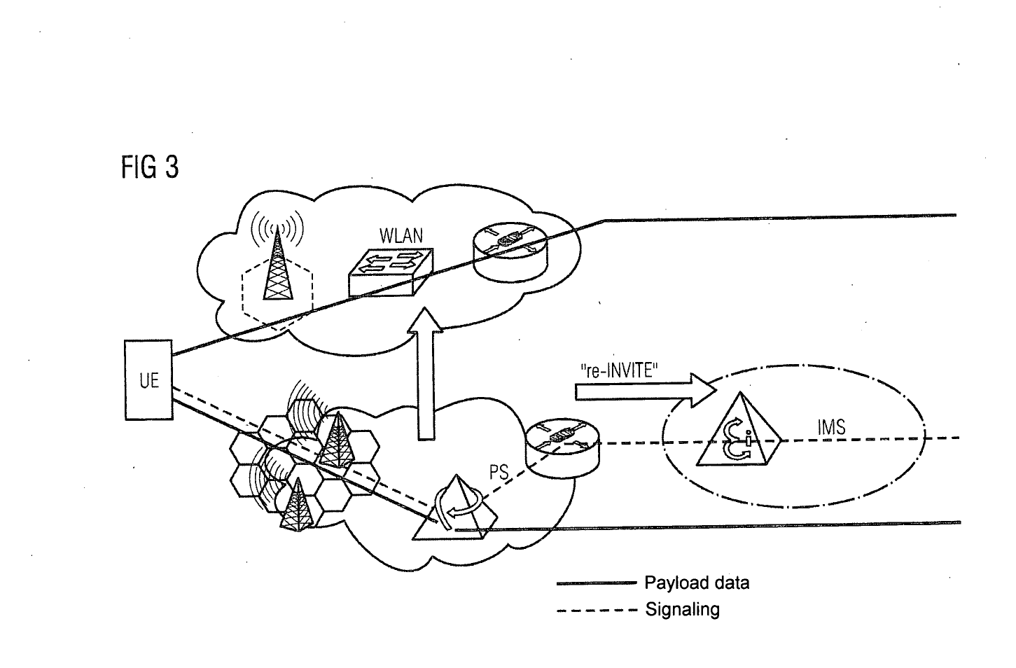

FIG. 3 shows a separation of signaling and payload data,

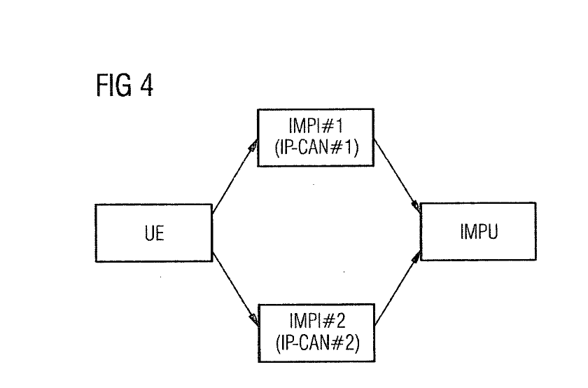

FIG. 4 shows an example of parallel registration,

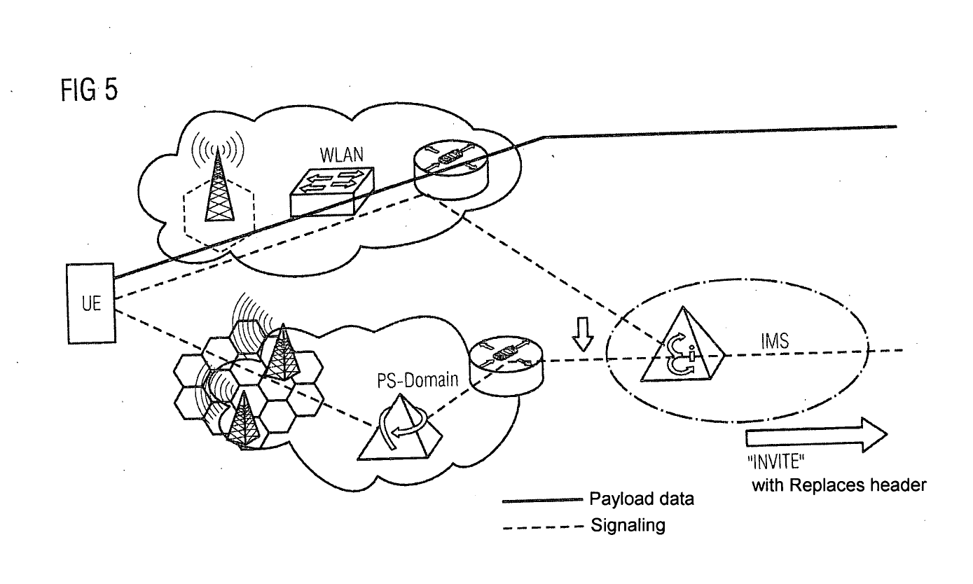

FIG. 5 shows the changeover of the signaling connection while maintaining the payload data connection,

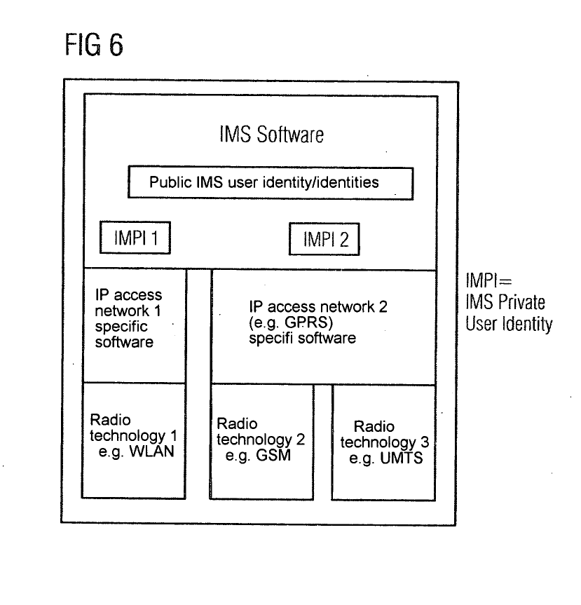

FIG. 6 shows an example of the separate processing for different radio technologies and communication access networks in the IP multimedia subsystem.

FIG. 1 shows a simplified system architecture with signaling and payload data which is transmitted over different communication access networks. In the IP multimedia subsystem IMS, or more generally in SIP networks (communication networks that use the SIP protocol for signaling), logically speaking the terminal UE maintains for a voice or data service firstly a signaling connection to the SIP servers in the communication network (in IMS: CSCF=Call State Control Function), and secondly a “connection” for the payload data (usually end-to-end). According to the invention, different communication access networks or IP access networks respectively can be used for the signaling and the payload data. This is enabled by the SIP/SDP protocol for example. The terminal UE can consequently send its payload data over the broadband WLAN network WLAN for example, but can route the SIP signaling to the IP multimedia subsystem IMS over the GPRS network PS (also known as “PS domain”, or “PS” for short)

FIG. 2 shows a changeover of the communication access network WLAN, PS from a WLAN network to a PS domain (GPRS network) for the payload data with an existing signaling connection over the GPRS network, which is retained. According to the invention, an existing signaling connection over one of the communication access networks WLAN, PS is retained during a changeover of the payload data connection from a first communication access network WLAN to a second communication access network PS. If, for instance, a signaling connection (for example a SIP dialog) exists over the second communication access network PS which controls or monitors the payload data connection (session) over the same or a different communication access network WLAN, PS, then a renewal of, for example, the SIP dialog by means of, for example, a re-INVITE message (re-INVITE) enables the payload data connection to be changed. In this case, the option to use different IP addresses or user identities respectively in SIP/SDP is used. If, for example, initially payload data is routed over a WLAN network WLAN but the signaling is routed over a GPRS network PS, then using the re-INVITE message it is possible from now on to also route the payload data over the GPRS network PS. Conversely, as shown in FIG. 3, by means of the re-INVITE message it is of course equally possible to separate the signaling and the payload data initially transmitted over the same communication access network PS.

FIG. 4 shows an example of parallel registration and the associated configuration. An IP communication network IMPU allocates the two private user identities IMPI#1 and IMPI#2 and two IP addresses to a public user identity of the user of the terminal UE. A terminal UE, which would now like to register itself in an IP communication network IMPU in parallel for the two communication access networks IP-CAN#1 and IP-CAN#2, registers itself in the IP communication network IMPU for the first communication access network IP-CAN#1 with the public user identity, the private user identity IMPI#1 and an IP address, and for the second communication access network IP-CAN#2 with the public user identity, the private user identity IMPI#2 and a further IP address. A terminal UE that is already registered in the IP communication network IMPU for the first communication access network IP-CAN#1 could register itself in parallel in the IP communication network IMPU for the second communication access network during a handover, and a simultaneous or staggered changeover of the payload data connection and the signaling connection from the first IP-CAN#1 to the second communication access network IP-CAN#2 could take place.

FIG. 5 shows the changeover of the signaling connection while maintaining the payload data connection. If the terminal UE is registered in the IP communication network over two different communication access networks WLAN, PS and has a payload data connection that was established over one of the communication access networks WLAN, then it is possible to hand over the control channel, that is to say the signaling connection, from a first communication access network WLAN to the second communication access network PS: SIP signaling is used for this purpose for example, namely either by means of a REFER message, which invokes a call diversion, or a new INVITE with “Replaces header”. The “Replaces header” causes one SIP dialog to replace another. In both cases the payload data connection is retained. According to the invention, the communication access network for the payload data connection can be optionally changed at the same time.

FIG. 6 shows an example of the separate processing for different radio technologies and communication access networks in the IP multimedia subsystem. The method according to the invention with the IMS software in the IP multimedia subsystem IMS is illustrated.

According to the invention, the method for the sample question “How can existing IP multimedia services be maintained when the radio technology, and consequently the IP access network, changes?” is as follows: The terminal UE is registered over a first communication access network 1 with the radio technology 1, for example WLAN, and uses packet-switching services. The terminal UE determines that it is necessary to change over the communication access network 1 with the radio technology 1, because of the falling quality of the radio link for example. The terminal UE then registers itself in parallel with the second communication access network 2 with the radio technology 2, for example a GSM network, or 3, for example a UMTS network. In order for this to be possible, two private user identities IMPI1 and IMPI2 (IMPI=IMS Private User Identity) are allocated to the terminal UE for the public user identity for the user of the terminal UE. For each communication access network 1, 2, the terminal UE preferably uses in each case one private user identity, the public user identity and in each case one IP address for registering in the IP communication network. Using the procedures described in FIGS. 1 to 4, the changeover of the voice or payload data connection to the second communication access network 2 can now be realized. The terminal UE can subsequently perform for the first communication access network 1 the SIP de-registration for the payload data connection in the IP communication network, here an IP multimedia subsystem IMS.

According to the invention, the method for the sample question “How can continuity of service be provided between a packet-based voice-over-IP connection in a WLAN network and a connection-oriented CS voice connection on a changeover of the radio technology between GSM/UMTS and WLAN?” is as follows: A terminal UE is registered over a communication access network 1 with one radio technology, here a WLAN network, and uses a voice connection over an IP communication network, here an IP multimedia subsystem. The terminal UE determines that it is necessary to change over the communication access network 1, because of the falling quality of the radio link for example. According to the invention, the terminal UE then registers itself in parallel with the second communication access network 2 with the radio technologies 2 (GSM) or 3 (UMTS). Using the procedure described in FIGS. 1 to 4, the changeover of the voice or payload data connection to the second communication access network 2 can now be realized. For this purpose, for example a re-INVITE message with “Replaces header” is sent with the necessary SIP/SDP information in order to
route the signaling now over the UMTS/GPRS communication access network 2 and the associated IP address;
initiate the establishment of a CS voice connection using “SIP 3rd party call control”. There are mechanisms which enable a CS connection (circuit-switched connection) to be viewed as a (possibly single) component of an IMS SIP connection. The terminal UE can subsequently perform for the first communication access network 1 the SIP de-registration for the voice or payload data connection in the IP communication network.

If the terminal UE uses a multimedia connection, for example a video, audio, voice service etc., in which one of the components is voice, the method described can also be used to perform a handover in which, following the changeover of the communication access network 1 to the GSM/UMTS communication network 2, the voice connection is transmitted in the CS domain, whereas the other components are transmitted in the GPRS/UMTS PS domain (packet-switched). A re-INVITE signaling with “Replaces header” must then be performed here, and in addition the procedure according to FIG. 2 of the packet-switched payload data connection must be performed.

In certain applications (for example given complete GSM/UMTS coverage), it is also possible to avoid the handover of the signaling channel by routing the signaling permanently over the GPRS/UMTS communication access network 2, even if the payload data use the WLAN network 1 for example. Maintenance of the signaling connection is thus always ensured, and only the procedure according to FIGS. 2 to 4 need be considered on leaving the WLAN coverage area. In some circumstances, a CS connection (circuit-switched connection) must additionally be viewed as a (possibly single) component of an IMS SIP connection.

1. A method for maintaining at least one data connection to a terminal during a changeover from a first communication access network to at least one second communication access network,
comprising:
at least two private user identities and at least two IP addresses allocated to the terminal in order to form a public user identity for the user of the terminal,
wherein the terminal registers itself in an IP communication network in parallel per communication access network with in each case one private user identity and with the common public user identity and an IP address for the first communication access network and the at least one second communication access network.

2. The method as claimed in claim 1,
wherein
an IP multimedia subsystem is used as the IP communication network.

3. The method as claimed in claim 2,
wherein
a private IMS user identity and/or a user identifier are used as the private user identity.

4. The method as claimed in claim 3,
wherein
the private IMS user identity is configured by the terminal and/or a network unit.

5. The method as claimed in claim 1,
wherein
a public IMS user identity is used as the public user identity.

6. The method as claimed in claim 5,
wherein
the public IMS user identity is a SIP-URI and/or a Tel-URI.

7. The method as claimed in claim 1,
wherein
a data connection is a payload data connection and/or a signaling connection.

8. The method as claimed in claim 1,
wherein
the terminal sends and/or receives signaling data for the same data connection over the first communication access network and payload data over the at least one second communication access network.

9. The method as claimed in claim 1,
wherein
a changeover of the payload data connection from the first communication access network to at least one second communication access network is performed using at least one signaling message.

10. The method as claimed in claim 1,
wherein
a changeover of the signaling connection from the first communication access network to at least one second communication access network is performed using at least one signaling message.

11. The method as claimed in claim 8,
wherein
the signaling is performed using at least one signaling message over the signaling connection to the first communication access network.

12. The method as claimed in claim 1,
wherein
a SIP protocol, a H.323 protocol and/or an IP-based signaling protocol is used as the signaling protocol.

13. The method as claimed in claim 10,
wherein
an INVITE, REFER and/or re-INVITE procedure is used in the SIP protocol.

14. The method as claimed in claim 11,
wherein
at least one re-INVITE signaling message and/or one INVITE signaling message contains a Replaces header.

15. The method as claimed in claim 1,
wherein
a packet-switching communication network, a WLAN network, a GPRS network and/or a cellular mobile radio network is used as the communication access network.

16. The method as claimed in claim 1,
wherein
following the changeover of the payload data connection from the first communication access network to at least one second communication access network, the terminal deregisters in the IP communication network for the first communication network.

17. The method as claimed in claim 1,
wherein
a mobile radio terminal, a mobile computer, a mobile organizer, a fixed network telephone and/or a computer is used as the terminal.
